(19) United States
(12) Patent Application Publication
(10) Pub. No.: US 2026/0204165 A1
(43) Pub. Date: Jul. 16, 2026

(54) TRAFFIC MANAGEMENT DEVICE, TRAFFIC MANAGEMENT SYSTEM, AND TRAFFIC MANAGEMENT METHOD

(71) Applicant: HITACHI, LTD., Tokyo (JP)

(72) Inventors: Kyoshiro ITAKURA, Tokyo (JP); Mutsumi MABUCHI, Tokyo (JP); Naoki WAKIZAKA, Tokyo (JP)

(21) Appl. No.: 19/443,221

(22) Filed: Jan. 8, 2026

(30) Foreign Application Priority Data
Jan. 14, 2025 (JP) 2025-004967

(51) Int. Cl. G08G 5/34; G05D 1/644; G05D 109/20; G06T 7/20; G06T 7/70; G07C 5/02; G08G 5/32; G08G 5/72

(52) U.S. Cl. CPC G08G 5/34; G05D 1/644; G06T 7/20; G06T 7/70; G07C 5/02; G08G 5/32; G05D 2109/20; G06T 2207/10032; G08G 5/72

(57) ABSTRACT

To provide a traffic management device, a traffic management system, and a traffic management method that are capable of creating a movement plan that takes into account a work purpose of a moving object. The traffic management device includes: an input unit that acquires work requirement information regarding a work indicator for evaluating work performed by a flying object, and environment information of an environment in which the flying object moves; a creation unit that creates the movement plan for the flying object such that an evaluation indicator for evaluating a degree of achievement of a work purpose of the flying object satisfies an evaluation criterion; and an output unit that outputs the movement plan, wherein the evaluation indicator is based on the work indicator that is obtained by comparing the work requirement information with the environment information and is in the movement environment of the moving object.

### BACKGROUND

The present invention relates to a traffic management device, a traffic management system, and a traffic management method that manage operation of a moving object.

Recently, a system has been proposed, which uses the moving object, which is an uncrewed aerial vehicle such as a drone, a robot which moves on the ground, or the like, to transport a package to a destination. In the transport system, it is important that the moving object be able to reach the destination and that predetermined work be efficiently performed.

International Publication No. WO 2021/064977 describes that “A screen for setting such a purpose as shown in FIG. 9 is displayed. For example, items such as transport, aerial photography, surveying, inspection, security, search, and boarding (on aircraft) may be possible as purposes. In the case of transport, as shown in FIG. 9, items for selection of the weight, size, and the like of an object to be transported may be possible”.

### SUMMARY

However, International Publication No. WO 2021/064977 describes that a purpose is set, but does not describe how the purpose is reflected in a movement plan.

In view of the above-described circumstances, an object of the present invention is to provide the traffic management device, the traffic management system, and the traffic management method that are capable of creating the movement plan that takes into account a work purpose of the moving object.

According to an aspect of the present invention, the traffic management device includes: an input unit that acquires work requirement information regarding a work indicator for evaluating work performed by the moving object, and environment information of an environment in which the moving object moves; a creation unit that creates the movement plan for the moving object such that an evaluation indicator for evaluating a degree of achievement of a work purpose performed by the moving object satisfies an evaluation criterion; and an output unit that outputs the movement plan, wherein the evaluation indicator is based on the work indicator that is obtained by comparing the work requirement information with the environment information and is in the movement environment of the moving object moves.

According to the present invention, the movement plan that takes into account a work purpose of the moving object is created.

### BRIEF DESCRIPTION OF THE DRAWINGS

FIG. 1 is an explanatory diagram showing an outline of a traffic management system according to a first embodiment of the present invention.

FIG. 2 is a block diagram showing a configuration of the traffic management system according to the first embodiment.

FIG. 3 is a block diagram showing a configuration of a path planning unit according to the first embodiment.

FIG. 4 is a flowchart showing a control process executed on a flying object by the traffic management system according to the first embodiment.

FIG. 5 is a flowchart showing a control process in a traffic management method executed by the traffic management system according to the first embodiment.

FIG. 6 is a conceptual diagram for explaining a method for creating a movement plan in the traffic management method according to the first embodiment.

FIG. 7 is an explanatory diagram showing an example of a display on a display screen in the traffic management method according to the first embodiment.

### DETAILED DESCRIPTION

### First Embodiment

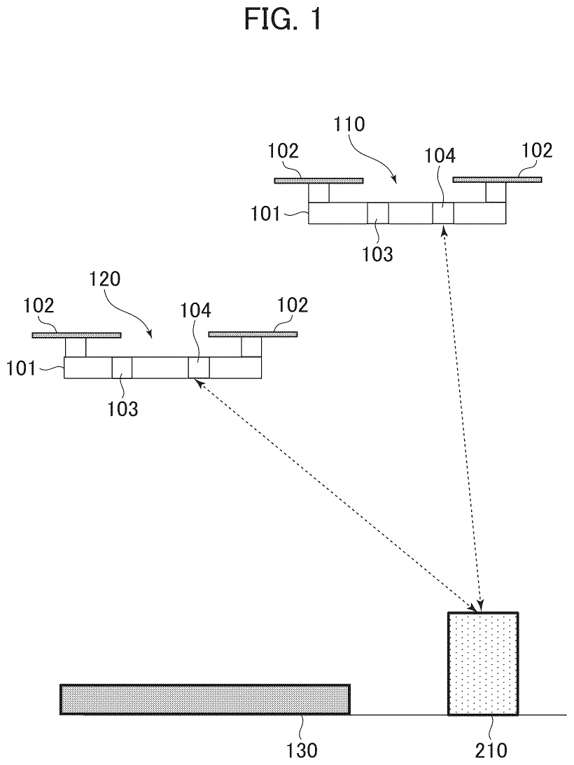

With reference to FIGS. 1 to 7, a traffic management system 100, a traffic management device 210, and the traffic management method according to the present embodiment will be described. In all of the drawings for explaining the present embodiment, the same components are denoted by the same reference signs, and repeated explanations thereof will be omitted.

In the following description, as an example, the moving object that is managed by the traffic management device 210, the traffic management system 100, and the traffic management method is an uncrewed flying object such as an electric vertical take-off and landing aircraft (eVTOL) or a drone. The moving object is not limited thereto, and may be a manned flying object such as an airplane. In addition, the moving object is not limited to a multi-rotor flying object, but may be another autonomously moving flying object or a ground-traveling robot.

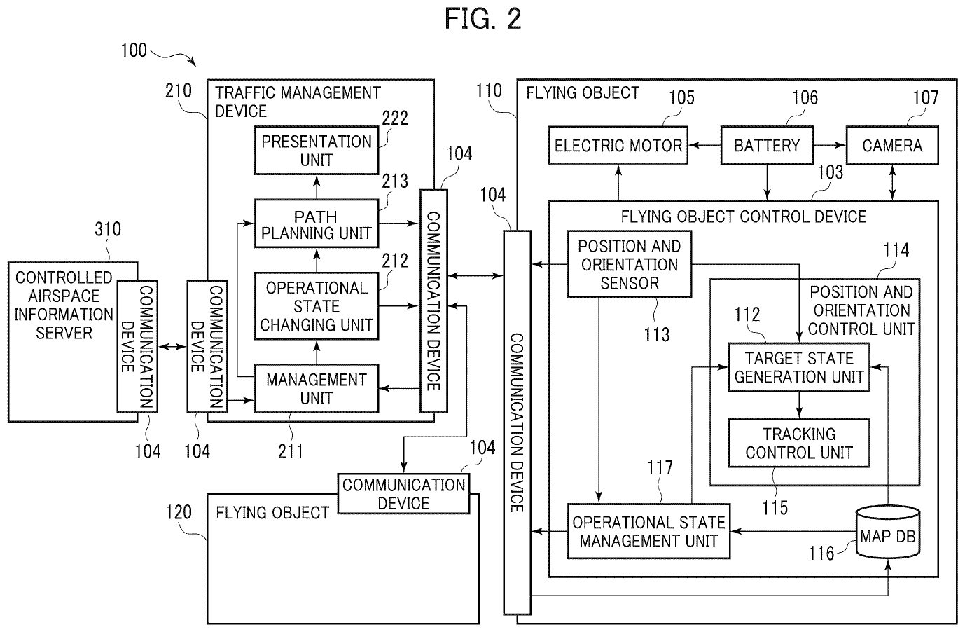

First, an overall configuration of the traffic management system 100 will be described with reference to FIGS. 1 and 2. FIG. 1 is a schematic diagram showing a system including flying objects 110 and 120, the traffic management device 210, and a takeoff and landing port 130. FIG. 2 is a block diagram showing a configuration of the traffic management system 100 according to the present embodiment. Some of components of the flying object 110 and the traffic management device 210 shown in FIG. 2 are schematic functional units, and do not mean that the components are necessarily physically present.

FIGS. 1 and 2 show, as the flying object 110, a representative configuration of a flying object, and show, as the flying object 120, the other of the plurality of the flying objects. The configuration of the flying object 120 is similar to that of the flying object 110, and not shown in detail in FIG. 2. The configuration of the flying object 120 may not be similar to that of the flying object 110 and may be different from that of the flying object 110. In the following, unless otherwise specified, the configuration in the present embodiment will be described by simply referring to the flying object as the “flying object 110”.

As shown in FIGS. 1 and 2, the flying object 110 includes a rectangular housing body 101, four blade rotors 102 disposed at positions symmetrical to the housing body 101, an electric motor 105 that drives each of the blade rotors 102, and a battery 106 for driving the electric motor 105. The flying object 110 according to the present embodiment is not limited thereto and may be the flying object capable of taking off and landing in a vertical direction.

The flying object 110 according to the present embodiment is used for inspection work for inspecting a target object by using a camera. Therefore, as shown in FIG. 2, the flying object 110 includes a camera 107 as an imaging device capable of photographing the target object. The camera 107 may be rotatably attached to the housing body 101 of the flying object 110 such that the orientation (optical axis) of the camera 107 relative to the housing body 101 can be freely changed, for example. In addition, the camera 107 may be fixedly attached to the housing body 101 so that the angle of view of the camera 107 is fixed, for example. In any of the cases, the orientation of the camera 107 relative to the housing body 101 of the flying object 110 can be recognized.

In the housing body 101, a flying object control device 103 that includes a position and orientation sensor 113, and a communication device 104 that communicates with the traffic management device 210 at the position of the flying object 110 and in a route through which the flying object 110 passes are disposed. The position and orientation sensor 113 includes a known GNSS sensor and an inertial measurement device that detect the position and orientation of the housing body 101.

The flying object control device 103 obtains altitude information of a movement route from route information indicating the movement route of the flying object 110 on a horizontal plane and height reference values indicating the elevation of a ground surface directly below each of a plurality of positions on the movement route. Specifically, values obtained by adding a flight altitude (the altitude of the flying object 110 from the ground surface) corresponding to a flight position on the movement route to the height reference values are set as the altitude information of the movement route. Therefore, the flying object 110 can fly along the movement route without colliding with the other flying object 120 and obstacles.

The traffic management device 210 distributes a movement plan to the flying object 110 to manage the operation of the flying object 110. The movement plan includes the movement route along which the flying object 110 moves, and information of the time at which the flying object 110 moves along the movement route. The traffic management device 210 is separated from the takeoff and landing port 130 in FIG. 1, but may be integrated with the takeoff and landing port 130. Although FIG. 1 illustrates the single takeoff and landing port 130, a plurality of the takeoff and landing ports 130 may be provided. However, the traffic management device 210 is assumed to instruct the flying object 110 to approach at least one takeoff and landing port 130, and the flying object 110 is not assumed to receive a plurality of movement instructions from the plurality of the traffic management devices 210.

Next, the traffic management system 100 including one or more flying objects 110 according to the present embodiment and the traffic management device 210 will be described with reference to FIG. 2.

As shown in FIG. 2, the traffic management system 100 includes the flying object 110, the traffic management device 210, and a controlled airspace information server 310.

The flying object 110 includes the flying object control device 103 and the communication device 104.

The flying object control device 103 is constituted by a computer including a processing device such as a central processing unit (CPU), a micro-processing unit (MPU), or a digital signal processor (DSP), a nonvolatile memory such as a read-only memory (ROM), a flash memory, or a hard disk drive, a volatile memory such as a random-access memory (RAM), an input interface, an output interface, and a peripheral circuit. As the flying object control device 103, an application specific integrated circuit (ASIC), a field programmable gate array (FPGA), or the like can be used. The nonvolatile memory and the volatile memory function as storage devices for storing information (data).

In the nonvolatile memory, a program that can perform various calculations is stored. That is, the nonvolatile memory is a storage device (storage medium) that can read the program that implements functions according to the present embodiment. The flying object control device 103 is an arithmetic device that expands the program stored in the nonvolatile memory into the volatile memory and executes the program. The flying object control device 103 performs predetermined arithmetic processing on data received from the input interface, the nonvolatile device, and the volatile memory, which are storage devices, in accordance with the program.

The flying object control device 103 is connected to the communication device 104, the electric motor 105, the battery 106, and the camera 107.

The input interface converts a signal input from various devices (the electric motor 105 and the like) into data that can be calculated by a processor. In addition, the output interface generates an output signal corresponding to a result of the calculation by the processor and outputs the signal to the various devices (the electric motor 105 and the like).

The flying object control device 103 includes the position and orientation sensor 113, a position and orientation control unit 114, a map database 116, and an operational state management unit 117.

The position and orientation sensor 113 detects position and orientation information of the flying object 110. The position and orientation information indicates the position and inclination of the flying object 110 in a global coordinate system. More specifically, the position and orientation sensor 113 detects the position of the flying object 110, and the inclination of the flying object 110 around the rotation axis of the flying object 110, such as a “yaw”, a “roll”, and a “pitch”. The position and orientation information detected by the position and orientation sensor 113 is input to the communication device 104, the operational state management unit 117, and a target state generation unit 112 in the position and orientation control unit 114 described later.

The position and orientation control unit 114 includes the target state generation unit 112 and a tracking control unit 115. Operational state management information from the operational state management unit 117, map information from the map database 116, and the position and orientation information from the position and orientation sensor 113 are input to the position and orientation control unit 114. In the position and orientation control unit 114, target state information indicating a target position and a target orientation is generated by the target state generation unit 112. The target state information is input to the tracking control unit 115.

The tracking control unit 115 has a function of causing the flying object 110 to autonomously operate according to any of a “landing mode”, a “takeoff mode”, and a “cruise mode” selected based on the target state information. The tracking control unit 115 controls the orientation of the flying object 110 by driving each electric motor 105 disposed in the flying object 110.

In the map database 116, at least the map information of a range in which the flying object 110 moves is stored.

The operational state management unit 117 manages operational states of the flying object 110. In this case, the operational states (modes) are the three modes that are the “landing mode”, the “takeoff mode”, and the “cruise mode”. In the “landing mode” and the “takeoff mode”, vertical movement and turning of the flying object 110 are performed. In the “cruise mode”, the movement along the movement route included in the movement plan is performed in accordance with the map database 116.

The communication device 104 outputs, to the traffic management device 210, the position and orientation of the flying object 110 detected by the position and orientation sensor 113 and the operational state of the flying object 110 transmitted from the operational state management unit 117. In addition, the communication device 104 inputs the route information distributed from the traffic management device 210 to the map database 116.

These functional elements are implemented by a control program stored in the flying object control device 103.

The controlled airspace information server 310 distributes, via the communication device 104, flight information of an airspace managed by the traffic management device 210, that is, current and future forecast information necessary for traffic management, such as weather conditions, radio wave conditions, and a flight position of an airplane. The traffic management device 210 receives information distributed from the controlled airspace information server 310 via the communication device 104 of the traffic management device 210 and inputs the information to a management unit 211 described later.

Next, the traffic management device 210 according to the embodiment of the present invention will be described.

The traffic management device 210 is constituted by a computer including a processor (processing device) such as a central processing unit (CPU), a micro-processing unit (MPU), or a digital signal processor (DSP), a nonvolatile memory such as a read-only memory (ROM), a flash memory, or a hard disk drive, a volatile memory such as a random-access memory (RAM), an input interface, an output interface, and another peripheral circuit. These hardware units coordinate with each other to operate software so as to implement a plurality of functions. A controller may be constituted by a single computer or may be constituted by a plurality of computers. As the processor, an application specific integrated circuit (ASIC), a field programmable gate array (FPGA), or the like can be used.

In the nonvolatile memory, the program that can perform various calculations is stored. That is, the nonvolatile memory is a storage medium (storage device) that can read the program that implement the functions according to the present embodiment. The volatile memory is a storage medium (storage device) that temporarily stores a result of calculation by the processor and a signal input from the input interface. The processor is a device that expands the program stored in the nonvolatile memory into the volatile memory and executes the program. The processor performs predetermined arithmetic processing on data received from the input and output interfaces, the nonvolatile device, and the volatile memory in accordance with the program.

The traffic management device 210 includes the communication device 104, the management unit 211, an operational state changing unit 212, a path planning unit 213, and a presentation unit 222.

The communication device 104 of the traffic management device 210 receives position and orientation information and an operational state from each flying object 110 and distribute the movement plan to each flying object 110. The position and operational state of each flying object 110 obtained from the communication device 104 is input to the management unit 211.

The management unit 211 manages the positions of all of the flying objects 110 recognized by the traffic management device 210 and a position and an operation plan for the flying object 110 to be newly managed. The operation plan is information including a work purpose of the flying objects 110 and 120, takeoff and landing times of the flying objects 110 and 120, and movement routes of the flying objects 110 and 120.

The environment information, the movement information, the moving object related information, and the work requirement information are input to and managed by the management unit 211.

The environment information is information regarding an environment in which the flying object 110 moves, and includes, for example, a no-fly zone, an area with a poor wind condition, and other flying object information. In the present embodiment, information regarding the position of the sun at a location (position on the map) and time.

The movement information includes a departure location and an arrival location of the flying object 110.

The moving object related information is information regarding the flying object 110, such as specifications of the flying object 110, and includes, for example, specification information of the weight of the flying object and the maximum flight speed, movement performance (for example, a communicable range with the controller or the like) of the flying object 110, the remaining battery level of the flying object 110, the sensor performance (for example, the performance of the position and orientation sensor 113) of the flying object 110.

The work requirement information is information regarding a work indicator for evaluating work performed by the flying object 110, and relates to, for example, the work indicator for evaluating the work such as photography, inspection, and pesticide spraying by the flying object 110.

In the present embodiment, as described above, the flying object 110 moves for the purpose of inspection using the camera, and the work requirement information includes a calculation equation for a light effect level λ as the work indicator, a calculation equation for a work requirement sufficiency level as an evaluation indicator, an evaluation threshold value for the evaluation criterion for determining whether the movement plan satisfies a request, information of a photographing location as location information, status information indicating whether work has been completed, specification information of the resolution of the camera to be used for inspection and a photographable distance of the camera, the orientation of the camera relative to the flying object 110, and the like.

The operational state changing unit 212 switches between the “cruise mode” and “the landing mode” according to, for example, a current distance to a destination based on input from the management unit 211, and outputs a result of selecting an operational state corresponding to the mode to the communication device 104. A signal corresponding to the result of the selection is transmitted from the communication device 104 to each flying object 110.

The path planning unit 213 creates the movement plan according to the environment information regarding the position, the route, and the flight airspace of each flying object 110 obtained from the management unit 211, and the operational state obtained from the operational state changing unit 212, and transmits the created movement plan to each flying object 110 via the communication device 104 of the traffic management device 210.

The presentation unit 222 is a display device for presenting the movement plan for the flying object 110.

In the present embodiment, the presentation unit 222 is disposed in the traffic management device 210, but may be a display device capable of presenting information to an operator who operates each flying object 110. For example, the presentation unit 222 may be a screen included in the controller or the like, and is not limited to the configuration described in the present embodiment.

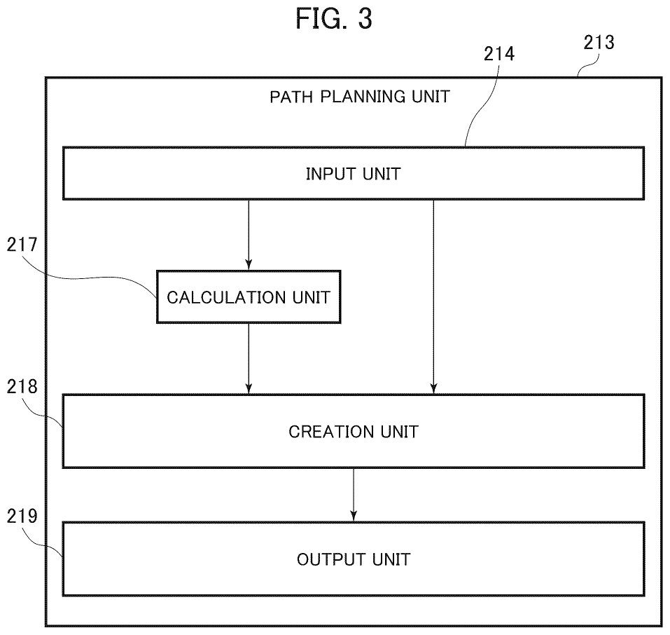

Next, a specific configuration of the path planning unit 213 will be described with reference to FIG. 3. FIG. 3 is a block diagram illustrating a detailed configuration of the path planning unit 213 illustrated in FIG. 2. FIG. 3 schematically illustrates a schematic functional unit of the path planning unit 213 as each component, and does not necessarily mean that the component is necessarily physically present.

As shown in FIG. 3, the path planning unit 213 includes an input unit 214, a calculation unit 217, a creation unit 218, and an output unit 219.

The input unit 214 acquires, from the management unit 211, information necessary for creating the movement plan and transmits the acquired information to the calculation unit 217 and the creation unit 218.

The environment information and the moving object related information are input to the calculation unit 217 from the input unit 214. The calculation unit 217 calculates, based on the environment information and the moving object related information, a range in which the flying object 110 can safely fly. The calculation unit 217 can determine a movable region by geometric calculation, flight simulation, or the like.

The environment information, the moving object related information, and the work requirement information are input to the creation unit 218 from the input unit 214. The creation unit 218 creates the movement plan for the flying object 110 in the cruise mode based on the information acquired from the input unit 214.

The creation unit 218 creates the movement plan for the flying object 110 so that the work purpose of the flying object 110 is achieved under predetermined constraints.

The constraints are set based on the environment information, the moving object related information, and the work requirement information registered in the management unit 211. The constraints include, for example, flight distance and flight time constraints based on a battery capacity, a mechanically trackable object route, a required approach distance (distance at which an image can be captured with inspectable resolution) to an inspection target object based on the resolution of the camera, a viewing angle (coverage area of the camera) of the camera relative to a moving direction on the flight route, and the like.

In addition, the creation unit 218 obtains the work indicator for the work to be performed by the flying object 110 based on the environment information and the work requirement information, evaluates, based on the work indicator, whether the work purpose of the flying object 110 has been achieved, and creates the movement plan satisfying the evaluation criterion. Further, the creation unit 218 creates the movement plan such that the evaluation of the achievement of the purpose by the flying object 110 is improved within the movable region calculated by the calculation unit 217. For example, in a case where the flying object 110 performs inspection by causing the camera to capture an image, the evaluation criterion can be calculated based on a degree of error in the shooting angle of the camera that is determined from a required shooting angle and the direction of the flight route. The creation unit 218 may calculate the evaluation criterion.

Specifically, a work indicator for each work content is set, an evaluation indicator indicating a degree of achievement of the work purpose of the flying object 110 is calculated for the movement plan from a work indicator of work when the flying object 110 flies based on the movement plan, and the movement plan is optimized such that the evaluation indicator is maximized or minimized. A specific procedure for creating the movement plan by the creation unit 218 will be described later.

The output unit 219 outputs information of the movement plan created by the creation unit 218 in the format in which an air traffic controller and a drone operator can execute the plan, and visualizes the information on a user interface in a laptop computer or the like.

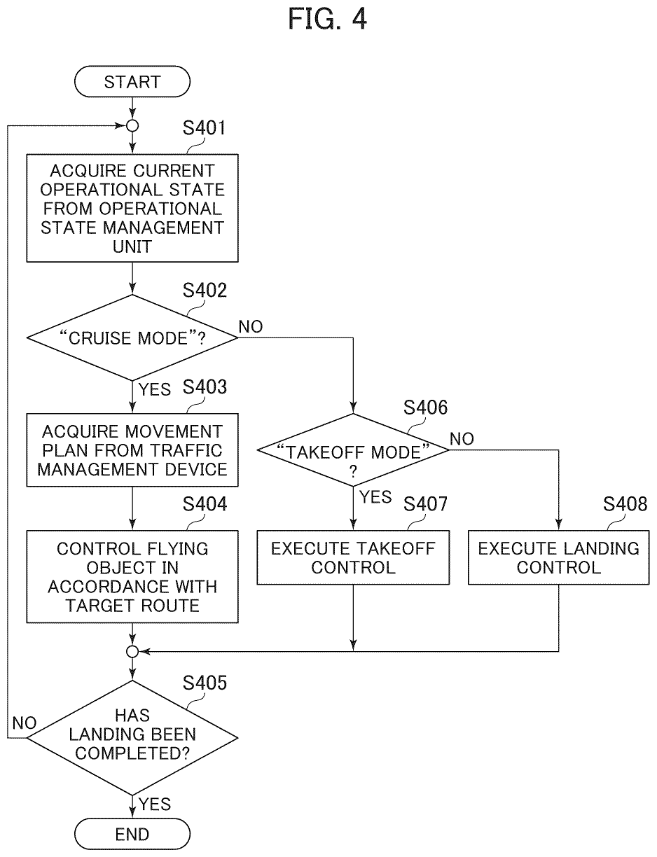

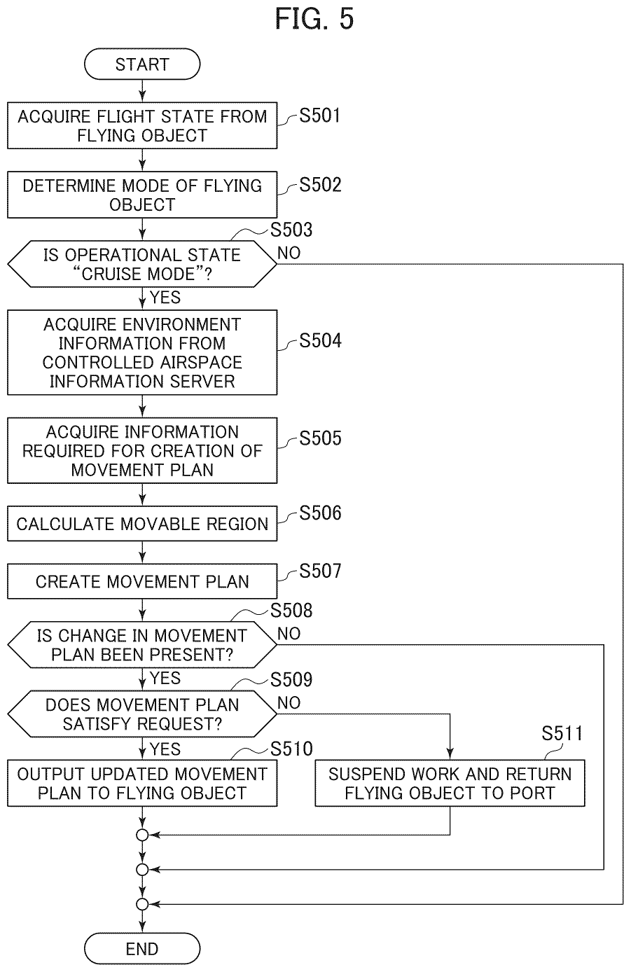

Next, with reference to FIGS. 4 to 5, the traffic management method according to the present embodiment will be described.

First, a control procedure for controlling flight (movement) of the flying object by the flying object control device 103 will be described.

### [Control Procedure for Setting Operational Mode]

FIG. 4 is a flowchart illustrating a control procedure for setting the operational state of the flying object by the flying object control device 103. That is, FIG. 4 is a flowchart illustrating a control process on the flying object 110 side in the traffic management system 100 according to the present embodiment.

### <<Step S401>>

In Step S401, the target state generation unit 112 acquires current position and orientation information as the current operational state from the operational state management unit 117. The position and orientation information can be acquired from the position and orientation sensor 113. When the current position and orientation information is acquired, the control process proceeds to Step S402.

### <<Step S402>>

In Step S402, the target state generation unit 112 determines whether the operational state acquired from the operational state management unit 117 is the “cruise mode”. In this determination step, the determination is performed based on information of the operational state sequentially transmitted from the operational state management unit 117. If the target state generation unit 112 determines that the operational state is the “cruise mode”, the control process proceeds to Step S403. If the target state generation unit 112 determines that the operational state is not the “cruise mode”, the control process proceeds to Step S406. Since a known technique can be used for the determination of the operational state based on the position and orientation information, a detailed description of the determination is omitted.

### <<Step S403>>

In Step S403, the target state generation unit 11 acquires the route information (movement plan) created by the traffic management device 210 and sets the acquired route information in the map database 116. After the setting is completed, the control process proceeds to the next Step S404.

### <<Step S404>>

In Step S404, the target state generation unit 112 sets a target route based on the target position and the target orientation, based on the movement plan stored in S403 and the information obtained from the position and orientation sensor 113. In addition, the tracking control unit 115 controls the flying object 110 in accordance with the set target route. After the control is completed, the control process proceeds to Step S405.

### <<Step S405>>

In Step S405, the position and orientation control unit 114 determines whether the flying object has completely landed, based on the operational state in the operational state management unit 117 of the flying object 110. For example, the flight altitude is 0 meters on the ground, the position and orientation control unit 114 determines that the flying object has completely landed. The control process is ended when a landing completion flag is raised in Step S405. When the flag is not raised, the control process returns to Step S401, which is the start of the control process.

### <<Step S406>>

In Step S406, the position and orientation control unit 114 determines whether the operational state acquired from the operational state management unit 117 is the “takeoff mode”. In this determination step, the determination is performed based on information of the operational state sequentially transmitted from the operational state management unit 117. If the position and orientation control unit 114 determines that the operational state is the “takeoff mode” in Step S406, the control process proceeds to Step S407. If the position and orientation control unit 114 determines that the operational state is the not “takeoff mode” in Step S406, the control process proceeds to Step S408.

### <<Step S407>>

In Step S407, the position and orientation control unit 114 executes automatic takeoff control using an automatic takeoff mode control program registered (stored) in, for example, the flying object control device 103 in advance. When the execution of this control is completed, the control process proceeds to Step S405.

### <<Step S408>>

In Step S408, the position and orientation control unit 114 executes automatic landing control using an automatic landing mode control program registered (stored) in, for example, the flying object control device 103 in advance. When the execution of this control is completed, the control process proceeds to Step S405.

The above-described procedure is the procedure for controlling the flying object 110 by the flying object control device 103. The procedure for controlling the flying object 110 is not limited to the content described above in the embodiment, and another known technique can be used for the procedure.

Next, a control procedure that is included in the traffic management method that is executed by the traffic management device 210 according to the present embodiment will be described. FIG. 5 is a flowchart illustrating the control procedure for creating the movement plan for the flying object 110 by the traffic management device 210. FIG. 5 is the flowchart illustrating a control process on the flight control side in the traffic management method according to the present embodiment.

### <<Step S501>>

As shown in FIG. 5, in Step S501, the management unit 211 acquires operation information such as the position, the orientation, and the operational state of the flying object 110 from the flying object 110 via the communication device 104. After the acquisition of the operation information is completed, the control process proceeds to Step S502.

### <<Step S502>>

In Step S502, the operational state changing unit 212 refers to the operation information acquired in Step S501, extracts the operation state, and determines which operational state the extracted operational state indicates. In addition, if the traffic management device 210 on the ground side determines that it is necessary to change the operational state, the operational state changing unit 212 performs a determination process of determining to which operational state the operational state has been changed, and transmits information of the determined operational state to the flying object 110. After the determination process is completed, the control process proceeds to Step S503.

### <<Step S503>>

In Step S503, the operational state changing unit 212 refers to the result of the determination in Step S502 and determines whether the result of the determination indicates the “cruise” mode. If the result is the “cruise” mode, the control process proceeds to Step S504. If the result is not the “cruise” mode, the control process is ended. The present embodiment is applicable to a change in the movement plan, such as a change in a flight environment during flight in the cruise mode, but is not limited thereto and is applicable to a change in the movement plan before takeoff other than the change in the flight environment.

### <<Step S504>>

In Step S504, the management unit 211 acquires controlled airspace information (environment information of a range in which the flying object moves) from the controlled airspace information server 310 via the communication device 104. The controlled airspace information includes weather information, wind information, radio wave quality information, movement status information of other flying objects, movement status information of an unknown flying object, and the like, and includes current and future forecasted information thereof. After the acquisition of the controlled airspace information is completed, the control process proceeds to the next Step S505.

### <<Step S505>>

In Step S505, the input unit 214 acquires various types of information including the environment information, the moving object related information, and the work requirement information that are necessary for creating the movement plan from information registered in the management unit 211, and transmits the acquired information to the creation unit 218. When the information is input to the creation unit 218, the control process proceeds to the next Step S506.

### <<Step S506>>

In Step S506, the calculation unit 217 calculates a movable region that is a range in which the flying object 110 can safely fly. The movable region is calculated based on, for example, the movable body related information including at least one of the movement performance (for example, a communicable range with the controller), the maximum flight speed, the weight, the battery capacity, and the sensor performance of the flying object 110, and the environment information including a no-fly zone, an area with a poor wind condition, and other flying object information.

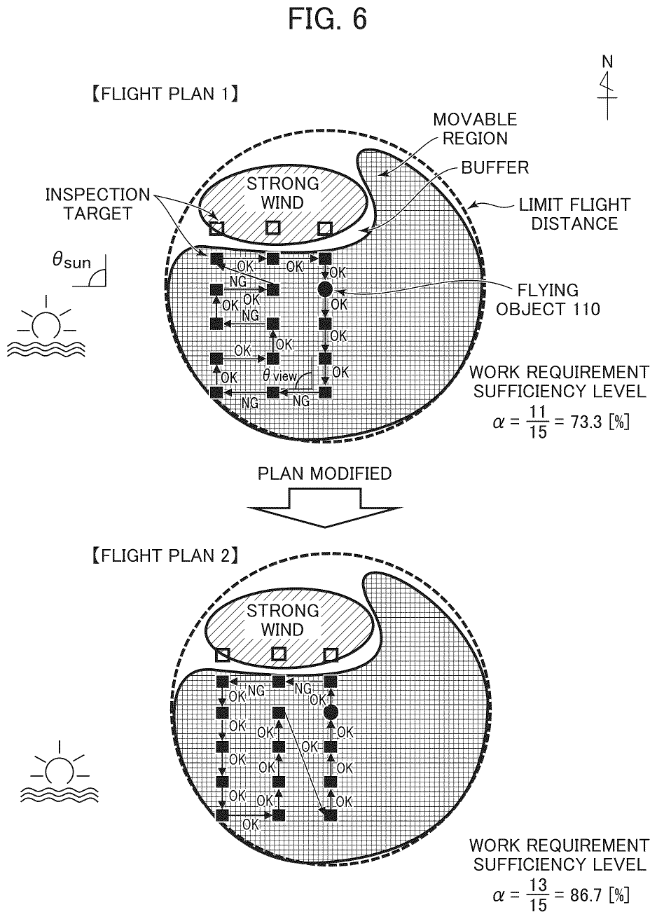

With reference to FIG. 6, a method for calculating the movable region will be described in detail. In the calculation of the movable region, first, an area that is in the airspace and where a strong wind occurs is identified from the environment information acquired from the input unit 214. In the airspace, a limit flight distance from the current location (a black circle at a central portion in the drawing) of the flying object 110 is identified based on the moving object related information. The limit flight distance can be identified based on the moving object related information of at least one of a limit due to the communicable range with the controller, a limit due to the remaining battery level, and a limit due to the communicable range with the position and orientation sensor 113.

An area that is included in an area included in the limit flight distance and excludes a strong wind area (diagonal shaded area in FIG. 6) and an area with a buffer around the strong wind area to prevent the flying object from approaching the strong wind area is set as the movable region (grid shaded area in FIG. 6). By setting the movable region in this manner, a safe range in which the flying object 110 flies can be defined.

### <<Step S507>>

In Step S507, the creation unit 218 creates the movement plan.

The creation of the movement plan will be specifically described with reference to FIG. 6. First, an inspection target object (black square in FIG. 6. A white square is not an inspection target object because the white square is not in the movable region) that is present in the movable region among all of inspection targets is extracted, and the movement plan for photographing the inspection target is created. However, the air traffic controller may freely select an inspection target object in the movement region. The movement plan is created on the condition that, in addition to the preset constraints, the flying object passes through all of photographing locations for photographing the inspection target object that is present within the movable region. A known technique can be used for a method for creating a route that passes through a predetermined location under specific constraints, and therefore a detailed description of the method will be omitted.

Next, a work indicator for the created movement plan is obtained. The work indicator is a light effect level λ expressed by Equation (1). The light effect level λ indicates whether the effect of sunlight (so-called overexposure) occurs when the inspection target object is photographed by the camera 107 at each of the photographing locations. In the present embodiment, the light effect level λ is defined based on a deviation between a solar radiation direction θₛᵤₙ and the azimuth angle view of the camera 107 directed toward the inspection target object. In other words, the light effect level λ is an angle formed by a vector extending from the sun to the inspection target object and a vector extending along the optical axis of the camera directed toward the inspection target object. By substituting the solar radiation direction θₛᵤₙ based on the position of the sun as environment information into Equation (1) managed as the work requirement information, it is possible to obtain a work indicator in a movement environment in which the flying object 110 currently moves.

$$\begin{matrix}[ Equation 1 ] & \\ light effect level λ = \vert {θ}_{view} - {θ}_{sun} \vert & ( 1 )\end{matrix}$$

Next, an evaluation indicator for the created movement plan is calculated based on the work indicator, and whether the evaluation indicator satisfies the evaluation criterion is determined (evaluated). The evaluation indicator is a work requirement sufficiency level α that is a ratio of a photographing location where the light effect level λ is lower than a desired threshold value (for example, 45 degrees), and is obtained by the following Equations (2) and (3).

$$\begin{matrix}[ Equation 2 ] & \\ if λ \leq 45 [ deg ] & ( 2 )\end{matrix}$$

$$σ = 0$$

$$else$$

$$σ = 1$$

$$\begin{matrix}[ Equation 3 ] & \\ work requirement sufficiency level α = \frac{{\sum }_{i = 1}^{n} {σ}_{n}}{n} \times 100 [ \% ] & ( 3 )\end{matrix}$$

Specifically, in a case where the light effect level λ is greater than or equal to the threshold value, overexposure due to sunlight may occur in a photographed image, a work request is not satisfied, and an evaluation value σ at the photographing location (photographing location indicated as “NG” in FIG. 6) is set to 0. On the other hand, in a case where the light effect level λ exceeds the threshold value, overexposure does not occur (less occurs), the work request is satisfied, and the evaluation value σ at the photographing location (photographing location indicated as “OK” in FIG. 6) is set to 1. After the evaluation is performed at all of the photographing locations (photographing target locations), the ratio of the number (11 in a flight plan 1) of photographing locations where the light effect level λ satisfies the work request to the number of all of the photographing locations (n=15 in this case) is set as the work requirement sufficiency level α. For example, in the movement plan like the flight plan 1 illustrated in an upper portion of FIG. 6, the work requirement sufficiency level α for evaluation of the quality of the inspection work by the flying object 110 is calculated as 73.3%.

In this case, the movement plan is an inspection plan whose quality is higher as the work requirement sufficiency level α is higher. In the present embodiment, to improve the work requirement sufficiency level α, re-planning (repeated creation of the movement plan) is repeatedly performed until the work requirement sufficiency level satisfies a predetermined evaluation criterion. For example, a condition for satisfying the evaluation criterion is that the work requirement sufficiency level α exceeds a predetermined evaluation threshold value (for example, 85%), and the movement plan is repeatedly created until a movement plan (flight plan 2 illustrated in a lower portion of FIG. 6) for which the work requirement sufficiency level α exceeds the evaluation threshold value is created.

To repeatedly create the movement plan and satisfy the evaluation criterion, a known optimization algorithm and a known search algorithm can be used. For example, the movement plan that satisfies the evaluation criterion can be created by an algorithm for solving a mathematical optimization problem where the evaluation cost is the work requirement sufficiency level α.

To create the movement plan that satisfies the evaluation criterion, the creation unit 218 can be constituted by a machine learning model that has learned the relationship between the light effect level λ and the orientation of the camera 107, for example. In this case, by inputting a parameter required for creating the movement plan to the machine learning model, the machine learning model generates the movement plan that satisfies the evaluation criterion. The method for optimizing the movement plan is not limited thereto.

By the above-described method, the movement plan that includes a safe and efficient work plan (in other words, satisfies the evaluation criterion) is created. The creation unit 218 creates the movement plan based on the environment information, the movable body related information, and the work requirement information. Therefore, in a case where the information is not changed, the movement plan created is basically the same as the movement plan created in the previous cycle. That is, the creation unit 218 recreates a new movement plan in a case where the environment information is changed, for example.

As described above, when the movement plan that satisfies the evaluation criterion is created, the control process proceeds to Step S508.

### <<Step S508>>

In Step S508, the creation unit 218 compares the movement plan created in Step S507 with the current movement plan (movement plan created in the previous cycle) and determines whether a change in the movement plan is present. If the creation unit 218 determines that the change in the movement plan is present, the control process proceeds to Step S509. If the creation unit 218 determines that the change in the movement plan is not present, the control process is ended.

### <<Step S509>>

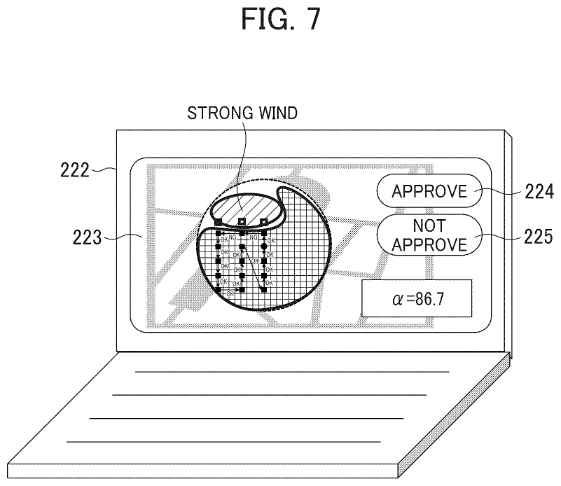

In Step S509, the creation unit 218 transmits the movement plan created in Step S507 to the output unit 219. In addition, the output unit 219 transmits a signal including the movement plan to the presentation unit 222 of the traffic management system 100 illustrated in FIG. 7 and waits for a response from the presentation unit 222. Therefore, the movement plan is displayed in a user interface on the presentation unit 222, and the air traffic controller or the operator can visually check the movement plan. More specifically, for example, as illustrated in FIG. 7, map data of an area around an area where the flying object 110 moves is displayed on a display 223 in the presentation unit 222, and the movement created on the map data and the work requirement sufficiency level α are aligned and then superimposed and displayed on the map data. In addition, an approve button 224 is arranged on the user interface. When the air traffic controller checks the created movement plan and the work requirement sufficiency level α and determines to perform the work, the air traffic controller presses the approve button 224 on the user interface for approval, a response signal indicating the approval is input to the output unit 219, and the control process proceeds to Step S510. On the other hand, if the work requirement sufficiency level α of the movement plan does not satisfy the request, the air traffic controller presses a not approve button 225 for non-approval, and the control process proceeds to Step S511.

### <<Step S510>>

In Step S510, the path planning unit 213 transmits the new movement plan to the flying object 110 via the communication device 104 and ends the process.

### <<Step S511>>

In Step S511, since the work requirement is not satisfied and the movement plan is not approved, the inspection work is suspended, the flying object returns to the port, and the process is ended.

The processing in Steps S501 to S511 is performed at any update interval until the flying object 110 completes the work and transitions to the landing mode.

Since the air traffic controller or the operator operates the flying object while referring to the information on the presentation unit 222 in the above-described manner, safe and highly useful remote work can be performed.

According to the above-described embodiment, the following operational effects are obtained.

According to this embodiment, the movement plan that takes into account the work for achieving the work purpose of the flying object 110 is created. Therefore, the flying object 110 can be meaningfully and efficiently operated.

More specifically, according to the present embodiment, in the inspection work for inspecting the target object using the camera, the movement plan that can reduce the effect (overexposure) of sunlight on a photographed image is created. Therefore, it is possible to improve the efficiency and accuracy of the inspection work by using the camera.

In addition, the creation unit 218 can create the movement plans for the plurality of the flying objects 110 in parallel or serially and can automatically create a complex movement plan. This can reduce a load applied for the creation of the movement plans by the air traffic controller, contributing to a reduction in the number of people required for air traffic control.

In addition, the output unit 219 superimposes and outputs digital space information and the movement plan on each other to convert the digital space information and the movement plan into white box data and allows the user to visually confirm the safety and usefulness of the created movement plan. Therefore, it is possible to easily grasp that the created movement plan is safe and useful.

### Second Embodiment

Next, the traffic management device 210, the traffic management system 100, and the traffic management method according to a second embodiment of the present invention will be described. Components that are the same as or similar to the components described in the first embodiment are denoted by the same reference signs as those described in the first embodiment, and different features will be mainly described.

The present embodiment is different from the first embodiment in a work purpose (application or work content) of the flying object 110. In the present embodiment, the purpose of the flying object 110 is to spray a pesticide. The flying object 110 such as a drone is useful not only for work such as capturing an image by a camera, but also for work such as spraying a pesticide, and its use is expected.

In the present embodiment, environment information includes wind direction data and wind speed data for each area. Work requirement information includes information such as a target area in which the pesticide is sprayed, the amount of the pesticide to be sprayed, and the spraying speed of the pesticide.

The creation unit 218 compares the moving object related information of a movement speed of the flying object 110 and the like with the environment information of the speed at which the pesticide is to be sprayed, the wind direction data, the wind speed data, and the like and calculates a pesticide dispersion range as a work indicator in a target area. Then, the creation unit 218 calculates, as an evaluation indicator, a degree of suitability of the calculated pesticide dispersion range for the target area in which the pesticide is to be sprayed. The number of definitions of the degree of suitability is not limited to one as long as the degree of suitability is an indicator indicating the degree of suitability (matching degree) of the calculated pesticide dispersion range for the target area. For example, the ratio of an area in which the target area overlaps the range in which the pesticide is to be sprayed relative to the target area can be calculated as the degree of suitability. Then, the movement plan is repeatedly created until the evaluation criterion is satisfied, specifically, until the movement plan in which the degree of suitability exceeds a predetermined evaluation value is created.

Since the movement plan is created based on the degree of suitability of the range in which the pesticide is to be sprayed for the target area, the moving object can efficiently spray the pesticide. For example, in an area where a north wind is blowing, spraying can be done more effectively by the flying object flying north of the target area.

### Third Embodiment

Next, the traffic management device 210, the traffic management system 100, and the traffic management method according to a third embodiment of the present invention will be described. The components that are the same as or similar to the components described in the first embodiment are denoted by the same reference signs as those described in the first embodiment, and the different features will be mainly described.

The present embodiment is different from the first embodiment in the work purpose (application or work content) of the flying object 110. In the present embodiment, the purpose of the flying object 110 is to perform logistics work (delivery work).

In the present embodiment, environment information includes information regarding whether a delivery area is indoors or outdoors, weather information such as the weather, wind direction data, wind speed data in the delivery area, and information regarding an obstacle that is present in the delivery area. Work requirement information includes location information indicating a location (location to which the flying object needs to move) to which delivery is to be made, information of a delivery arrival time desired by a user, and other information.

The creation unit 218 compares the moving object related information such as a movement speed with the environment information such as the weather information, and calculates, as a work indicator, an excess time at the delivery location within the delivery area in a created travel plan. The excess time is an amount of time by which an estimated delivery time exceeds the desired arrival time. In a case where the estimated delivery time does not exceed the desired arrival time, the excess time is calculated as zero. Then, the creation unit 218 calculates, as an evaluation indicator for the movement plan, the sum (sum of excess time in the entire movement plan) of excess time at each delivery location.

The evaluation indicator in the present embodiment only needs to indicate whether the user's desired arrival time is met, and in a case where the estimated delivery time does not exceed the desired arrival time, the excess time may be calculated as a negative value. The number of definitions of the evaluation indicator is not limited to one. The evaluation indicator may not be the sum of the excess time and may be the average value, the maximum value, or the like of the excess time. In addition, the evaluation indicator may be calculated by weighting the excess time at each delivery location according to the delivery location.

Then, the creation unit 218 repeatedly creates the movement plan until the movement plan is created in which the evaluation index satisfies the evaluation criterion, specifically, the sum of the excess time is lower than a predetermined evaluation threshold value. Since the movement plan is created based on the excess time as a work requirement, the flying object 110 can efficiently perform the delivery work.

In addition, for example, in addition to the evaluation indicator satisfying the evaluation criterion, the creation unit 218 can set a priority for a work location in order from the earliest desired arrival time such that the earlier the desired arrival time, the higher the priority is, and create the movement plan in which delivery is made according to the priority order of priorities, thereby making it possible to make delivery at a time requested by a user.

### Fourth Embodiment

Next, the traffic management device 210, the traffic management system 100, and the traffic management method according to a fourth embodiment of the present invention will be described. The components that are the same as or similar to the components described in the first embodiment are denoted by the same reference signs as those described in the first embodiment, and the different features will be mainly described.

The present embodiment is different from the first embodiment in the type of the moving object and a purpose (application or work content) of work by the moving object. In the present embodiment, the moving object is not the flying object (drone) and is a transport vehicle (automatic transport robot) that travels on the ground, and the purpose of the moving object is to perform transport work in a factory.

Even when the moving object is the transport vehicle, the moving object includes the battery 106 as a power source, the electric motor 105 as a drive source, and a device corresponding to the flying object control device 103 as in the first embodiment. Therefore, a specific configuration of the transport vehicle will not be described in detail.

In the present embodiment, environment information includes information indicating an obstacle, a no-entry area, and the like in the factory. Work requirement information includes the work content (carrying in and carrying out), a work target object, information of a location where the work is performed, work information of another moving object, and the like.

The creation unit 218 compares the work requirement information with the environment information, and calculates, as a work indicator, work time and the number of work tasks in the created movement plan. In addition, the creation unit 218 calculates the number of work tasks per unit time as an evaluation indicator for the movement plan.

Then, the creation unit 218 compares an evaluation threshold value with the evaluation indicator and repeatedly creates the movement plan until the movement plan for which the evaluation indicator satisfies the evaluation criterion (for example, the number of work tasks per unit time exceeds the evaluation threshold value) is created. Since the movement plan is created based on the number of work tasks per unit time as a work requirement in the above-described manner, the transport can be efficiently performed. In this case, it is possible to create movable plans that avoid interference between routes by registering mutual movement plan information of the moving objects in the management unit 211.

Even in the traffic management device 210, the traffic management system 100, and the traffic management method according to each of the second, third, and fourth embodiments, effects similar to those obtained by the traffic management device 210, the traffic management system 100, and the traffic management method according to the first embodiment are obtained.

The following modifications are within the scope of the present invention, and it is possible to combine configurations described in the modifications with the configurations described above in the embodiments, combine configurations described above in the different embodiments, and combine configurations described in the following different modifications. In addition, part of the configuration of each of the examples can be subjected to addition, deletion, and replacement with respect to other configurations.

### <Modification 1>

In creation of the movement plan, the creation unit 218 may create the movement plan that takes into account an operation plan including information regarding the other flying object 120 that moves in the movable region of the flying object 110. The operation plan is input from the controlled airspace information server 310 to the traffic management device 210 and stored in the management unit 211. The creation unit 218 can create, from information included in the operation plan and indicating a movement route and time of the other flying object 120, the movement plan for the flying object 110 with a single constraint that the flying object 110 avoids the other flying object 120. Since the operation plan is used as a single condition for creation of the movement plan, the creation unit 218 creates the movement plan again every time the operation plan is changed.

According to the configuration, since the movement plan that takes into account the other flying object 120 is created, the movement plans for the plurality of the flying objects 110 and 120 can be optimized as a whole.

### <Modification 2>

In the above embodiment, the creation unit 218 creates the movement plan based on a movable region and an evaluation indicator that have been calculated by the calculation unit 217. Meanwhile, the movable region may be manually created by the user or created by another device and input to the traffic management device. That is, the configuration for the calculation unit 217 is not essential.

In the above embodiment, the movable region is calculated based on the environment information and the moving object related information. Meanwhile, as long as the region in which the flying object 110 can safely move can be calculated, information for calculation of the movable region is not limited to the environment information and the moving object related information.

In addition, in the creation of the movement plan for the flying object 110, ensuring safety is a prerequisite, and thus it is useful to create the movement plan based on the movable region. However, for example, in a case where safety can be ensured even without calculation of the movable region, it is not essential to create the movement plan based on the movable region.

### <Modification 3>

In the above embodiment, for the movement plan created by the creation unit 218 so as to satisfy the evaluation criterion, a process in which the air traffic controller or the like visually check and approves the movement plan is included (Step S509 in FIG. 5). Since this step is included, it is possible to reflect determination based on know-how of an expert in the movement plan.

Meanwhile, in a case where the traffic management system can stably create the movement plan that satisfies a user's request, the step of checking and approving by a person and a processing step (Step S511 in FIG. 5) associated with the step are not essential and can be omitted. For example, when Step S507 in FIG. 5 is executed, the control process may proceed to Step S510 and the movement plan may be output to the flying object 110. In addition, when Step S507 is executed, the movement plan may be output to the presentation unit 222 and the control process may proceed to Step S510 without the step of approving.

### <Others>

The embodiments described above are merely examples to help understand the concept of the present invention, and are not intended to limit the scope of the present invention. In the embodiments, various components may be added, removed, or replaced without departing from the spirit of the present invention.

For example, the various functional units described above in the embodiments may be implemented by using a circuit. The circuit may be a dedicated circuit that implements a specific function, or may be a general-purpose circuit such as a processor.

Some of the processes described in the embodiments may be implemented by using a general-purpose computer as basic hardware. The program that implements the processes described above may be stored in a computer-readable storage medium and provided. The program is stored in the storage medium as an installable file or an executable file. Examples of the storage medium include a magnetic disk, optical discs (CD-ROM, CD-R, DVD, and the like), magneto-optical discs (MO and the like), and a semiconductor memory. The storage medium may be any medium as long as the storage medium is readable by a computer. The program that implements the processes may be stored in a computer (server) connected to a network such as the Internet and may be downloaded into a computer (client) via the network.

That is, the program that is executed by the traffic management device that is a computer causes the computer to execute a step of acquiring work requirement information regarding a work indicator for evaluating work performed by the flying object 110, and environment information of an environment in which the moving object moves; a step of creating the movement plan for the flying object 110 such that an evaluation indicator for evaluating a degree of achievement of a work purpose of the flying object 110 satisfies the evaluation criterion; and a step of outputting the movement plan, and the evaluation indicator is based on the work indicator that is obtained by comparing the work requirement information with the environment information and is in the movement environment of the flying object 110.

The configurations, the operations, and the effects in the embodiments of the present invention configured as above will be described below.

(1) The traffic management system 100 includes the flying object 110 and the traffic management device 210. The traffic management device 210 includes: the input unit 214 that acquires work requirement information regarding a work indicator for evaluating work performed by the flying object 110, and environment information of an environment in which the flying object 110 moves; the creation unit 218 that creates the movement plan for the flying object 110 such that an evaluation indicator for evaluating a degree of achievement of a work purpose of the flying object 110 satisfies the evaluation criterion; and the output unit 219 that outputs the movement plan. The evaluation indicator is based on the work indicator that is obtained by comparing the work requirement information with the environment information and is in the movement environment of the flying object 110.

In addition, the traffic management device 210 calculates the evaluation indicator for the created movement plan based on the work indicator, and repeatedly creates the movement plan until the evaluation indicator satisfies the evaluation criterion.

The traffic management method includes: Step S505 acquiring work requirement information regarding a work indicator for evaluating work performed by the flying object 110, and environment information of an environment in which the flying object 110 moves; Step S507 of creating the movement plan for the flying object 110 such that an evaluation indicator for evaluating a degree of achievement of a work purpose of the flying object 110 satisfies the evaluation criterion; and Step S510 of outputting the movement plan. The evaluation indicator is based on the work indicator that is obtained by comparing the work requirement information with the environment information and is in the movement environment of the flying object 110.

According to the configuration, the movement plan that takes into account the purpose of the work to be performed by the flying object 110 is created. Therefore, the flying object 110 can be meaningfully and efficiently operated.

(2) The traffic management device 210 further includes the calculation unit 217 that calculates a movable region that is a region in which the flying object is allowed to move, by using the moving object related information and environment information that are information regarding the flying object, and the creation unit 218 creates the movement plan based on the evaluation indicator and the movable region.

In the traffic management device 210, the moving object related information includes at least one of movement performance of the flying object 110, a remaining battery level of the flying object 110, and sensor performance of the flying object 110, and the calculation unit 217 sets, for the movement environment of the flying object indicated in the environment information, a movement evaluation criterion based on at least one of the movement performance, the remaining battery level, and the sensor performance of the flying object 110, and calculates, as the movable region, a region satisfying the movement evaluation criterion.

According to the configuration, by taking into account the environment information and the moving object related information when the flying object 110 moves in a certain region in a constantly changing movement environment, a safe movement plan can be created while taking into account changes in flight risks such as weather forecasts. Therefore, it is possible to achieve the work purpose of the flying object 110 and the safety of the flying object 110, thereby enabling safer and more meaningful operation of the flying object 110.

(3) In the traffic management device 210, the environment information includes the position of the sun at a location and time, the input unit 214 acquires location information indicating a photographing location where the camera 107 of the flying object 110 photographs a target object, the work indicator is a light effect level λ for evaluating an effect of sunlight on an image obtained by photographing the target object by the camera 107, the creation unit 218 calculates the light effect level λ for each photographing location included in the movement plan based on the position of the sun and the orientation of the camera 107 that is mounted on the flying object 110 and photographs the target object, calculates, as the evaluation index for the movement plan, a ratio of the photographing location where the light effect level λ is lower than a threshold value at the photographing location, and creates the movement plan for which the evaluation index exceeds a predetermined evaluation value.

In this configuration, in inspection work for inspecting the target object using the camera, the movement plan that can suppress an effect of the sunlight on the image obtained by the photographing is created. Therefore, it is possible to improve the efficiency and accuracy of the inspection work by using the camera.

(4) In the traffic management device, the input unit 214 acquires location information indicating a movement location to which the flying object 110 needs to move, and the creation unit 218 assigns a priority to the location information and creates the movement plan based on the priority.

In the traffic management device 210, the work requirement information includes a desired arrival time for the flying object to arrive at the location indicated in the location information, the work indicator indicates an excess time by which an estimated arrival time exceeds the desired arrival time, the creation unit 218 sets the priority based on the desired arrival time, and creates the movement plan that satisfies the priority and for which the work indicator is lower than a predetermined evaluation threshold value.

In this configuration, it is possible to create the movement plan suitable for a user's need by setting a priority based on the purpose of the flying object 110.

(5) In the traffic management device 210, the creation unit 218 creates the movement plan based on the evaluation indicator and an operation plan including information regarding the other moving object 120 that moves in the movable region.

In this configuration, since the movement plan is created based on information of the other flying object 120 in the movable region, it is possible to optimize the movement plans for the plurality of the respective flying objects 110 and 120.

(6) In the traffic management device 210, the creation unit 218 recreates the movement plan when the operation plan or the environment information is changed.

In this configuration, the flying object can move according to changes in the operation plan and the environment information, and can perform safe and useful movement (work).

Although the embodiments of the present invention are described above, the embodiments merely indicate some of the application examples of the present invention, and the technical scope of the present invention is not intended to be limited to the specific configurations described above in the embodiments.

What is claimed is:

1. A traffic management device comprising:
an input unit that acquires work requirement information regarding a work indicator for evaluating work performed by a moving object, and environment information of an environment in which the moving object moves;
a creation unit that creates a movement plan for the moving object such that an evaluation indicator for evaluating a degree of achievement of a work purpose of the moving object satisfies an evaluation criterion; and
an output unit that outputs the movement plan, wherein
the evaluation indicator is based on the work indicator that is obtained by comparing the work requirement information with the environment information and is in the movement environment of the moving object.

2. The traffic management device according to claim 1, further comprising:
a calculation unit that calculates a movable region in which the moving object is allowed to move, by using the moving object related information regarding the moving object and the environment information, wherein
the creation unit creates the movement plan based on the evaluation indicator and the movable region.

3. The traffic management device according to claim 2, wherein
the moving object related information includes at least one of movement performance of the moving object, a remaining battery level of the moving object, and sensor performance of the moving object, and
the calculation unit sets a movement evaluation criterion for the movement environment of the moving object indicated by the environment information based on at least one of the movement performance, the remaining battery level, and the sensor performance of the moving object, and calculates a region that satisfies the movement evaluation criterion as the movable region.

4. The traffic management device according to claim 1, wherein
the creation unit calculates the evaluation indicator for the created movement plan based on the work indicator, and repeatedly creates the movement plan until the evaluation indicator satisfies a predetermined evaluation criterion.

5. The traffic management device according to claim 4, wherein
the environment information includes the position of the sun at a location and time, the input unit acquires location information indicating a photographing location where a target object is photographed by a camera disposed in the moving object,
the work indicator is a light effect level λ for evaluating an effect of sunlight on an image of the target object captured by the camera, and
the creation unit
calculates the light effect level λ for each photographing location included in the movement plan, based on an orientation of the camera that photographs the target object and is disposed in the moving object and the position of the sun,
calculates, as the evaluation indicator for the movement plan, a work requirement sufficiency level that is a ratio of the photographing location where the light effect level λ is lower than a threshold value at the photographing location, and
creates the movement plan for which the work requirement sufficiency level exceeds a predetermined evaluation threshold value.

6. The traffic management device according to claim 1, wherein
the input unit acquires location information indicating a movement location to which the moving object needs to move, and
the creation unit assigns a priority to the movement location and creates the movement plan based on the priority.

7. The traffic management device according to claim 6, wherein
the work requirement information includes a desired arrival time for the flying object to arrive at the movement location,
the work indicator is an excess time by which an estimated arrival time exceeds the desired arrival time, and
the creation unit sets the priority based on the desired arrival time and creates the movement plan that satisfies the priority and for which the work indicator is lower than a predetermined evaluation threshold value.

8. The traffic management device according to claim 2, wherein
the creation unit creates the movement plan based on the evaluation indicator and an operation plan including information regarding another moving object that moves in the movable region.

9. The traffic management device according to claim 8, wherein
the creation unit recreates the movement plan when the operation plan or the environment information is changed.

10. A traffic management system comprising:
the traffic management device according to claim 1; and
a moving object that moves based on the movement plan created by the traffic management device.

11. A traffic management method comprising:
a step of acquiring work requirement information regarding a work indicator for evaluating work performed by a moving object, and environment information of an environment in which the moving object moves;
a step of creating a movement plan for the moving object such that an evaluation indicator for evaluating a degree of achievement of a work purpose of the moving object satisfies an evaluation criterion; and
a step of outputting the movement plan, wherein
the evaluation indicator is based on the work indicator that is obtained by comparing the work requirement information with the environment information and is in the movement environment of the moving object.
